(19) United States
(12) Patent Application Publication
(10) Pub. No.: US 2015/0302420 A1
(43) Pub. Date: Oct. 22, 2015

(54) COMPLIANCE FRAMEWORK FOR PROVIDING REGULATORY COMPLIANCE CHECK AS A SERVICE

(71) Applicant: MPhasis, Bangalore (IN)

(72) Inventor: Suresh Gopalakrishnan NAIR, Princeton, NJ (US)

(73) Assignee: MPHASIS, Bangalore (IN)

(21) Appl. No.: 14/609,935

(22) Filed: Jan. 30, 2015

(30) Foreign Application Priority Data
Apr. 22, 2014 (IN) 2052/CHE/2014

(51) Int. Cl. G06Q 30/00

(52) U.S. Cl. CPC G06Q 30/018

(57) ABSTRACT

A computer-implemented compliance framework for providing regulatory compliance check as a service to a financial organization is described. The compliance framework includes a discovery module configured to discover a plurality of business and operating rules of the financial organization. The compliance framework creates an organization knowledge model based on the plurality of business and operating rules of the financial organization. Additionally, the compliance framework builds industry knowledge model and regulatory knowledge model that includes a plurality of industry standard processes and a plurality of regulatory rules. The compliance framework also includes a classification module to classify a plurality of events occurring in the financial organization. Further, the compliance framework includes a compliance module configured to check if each event of the plurality of events is in compliance with at least one of the plurality of business and operating rules, the plurality of industry standard processes and the plurality of regulatory rules.

### FIELD OF THE PRESENT APPLICATION

The present application generally relates to implementing regulatory compliance in an organization. More specifically, the present application relates to a system and method of providing a compliance framework for providing regulatory compliance check as a service to a financial organization.

### BACKGROUND OF THE PRESENT APPLICATION

Financial industry is required to adhere to compliance requirements that are set by governments and various regulatory bodies. However, increasing compliance requirements are leading to a tougher operating environment for the financial industry including, but not limited to, banking and insurance. Regulators are taking stronger actions against non-compliance by imposing huge penalties and causing potential loss of reputation for non-compliant party.

The financial industry especially banks are seeing rising costs of compliance as a percentage of overall expenditure due to extensive reporting requirements by any regulatory body. Further, it is cumbersome for the banks to be updated with changes or additions in regulations. Such banks need to ensure regulatory compliance despite using multiple diverse and siloed systems. As a result, such banks chose to invest in separate silos of compliance technology each time a regulation is added/modified. This produces a challenge for balancing the cost of compliance and at the same time drive revenue growth.

Furthermore, banks need to address changes in internal ecosystem. Each time new IT systems are introduced or existing IT systems are modified within the banks, the IT systems need to identify which regulatory controls apply.

Currently technology exists that allows regulations to be encoded into a format that can be analyzed and consumed by a knowledge driven learning system. However, this approach does not disclose details about how regulations should be enforced or how regulation changes affect existing business process of a bank.

Also, a monolithic regulation enforcement system is used that may change existing IT systems of a bank when new regulations are introduced or when existing regulations are modified.

Thus, there is accordingly a need for a method and system for combining functions of discovering financial regulations that apply to a business of a financial organization with enforcement of such financial regulations and providing a single seamless solution.

### BRIEF DESCRIPTION OF DRAWINGS

The accompanying figures wherein like reference numerals refer to identical or functionally similar elements throughout the separate views and which together with the detailed description below are incorporated in and form part of the specification, serve to further illustrate various embodiments and to explain various principles and advantages all in accordance with the present application.

FIG. 1 illustrates a simplified diagram of a system including a computer implemented compliance framework configured to provide regulatory compliance check as a service to a financial organization in accordance with an embodiment of the invention.

FIG. 2 illustrates a computer implemented compliance framework for providing regulatory compliance check as a service to a financial organization in accordance with an embodiment of the invention.

FIG. 3 illustrates an exemplary lifecycle of compliance framework for providing regulatory compliance check as a service to a financial organization in accordance with an embodiment of the invention.

FIG. 4 illustrates a block diagram of a computing device with one or more instructions stored on a non-transitory computer-readable medium for providing regulatory compliance check as a service for a financial organization in accordance with an embodiment of the invention

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present application.

### DETAILED DESCRIPTION OF THE PRESENT APPLICATION

Before describing in detail embodiments that are in accordance with the present application, it should be observed that the embodiments may include providing a compliance framework for providing regulatory compliance check as a service to a financial organization. Accordingly, the method steps and system components have been represented where appropriate by conventional symbols in the drawings, showing only those specific details that are pertinent to understanding the embodiments of the present application so as not to obscure the disclosure with details that will be readily apparent to those of ordinary skill in the art having the benefit of the description herein.

In this document, the terms “comprises,” “comprising,” or any other variation thereof, are intended to cover a non-exclusive inclusion, such that a process, method, article, or apparatus that comprises a list of objects may include not only those objects but also include other objects not expressly listed or inherent to such process, method, article, or apparatus. An object preceded by “comprises . . . a” does not, without more constraints, preclude the existence of additional identical objects in the process, method, article, or apparatus that comprises the object.

Generally speaking, pursuant to various embodiments, the invention provides a computer implemented compliance framework for providing regulatory compliance check as a service to a financial organization. The compliance framework includes a discover module configured to discover a plurality of business and operating rules of the financial organization. The discover module is further configured to create an organization knowledge model by semantically analyzing the plurality of business and operating rules in response to the discover module discovering the plurality of the business and operating rules. The discover module is also configured to create an industry knowledge model based on a plurality of industry standard processes for a financial industry. Further, the discover module is configured to create a regulatory knowledge model based on a plurality of regulatory rules defined by a regulatory body. The compliance framework also includes a classification module configured to classify each event of a plurality of events occurring in the financial organization. The plurality of events is classified based on one or more of the organization knowledge model and the industry knowledge model. Additionally, the compliance framework includes a compliance module configured to check if each event of the plurality of events is in compliance with one or more regulatory rules of the plurality of regulatory rules. The one or more regulatory rules are identified based on the classification of an event. The compliance module is further configured to submit a subset of data corresponding to the plurality of events to the regulatory body. The subset of data is selected based on the plurality of regulatory rules. In addition, the compliance module is configured to verify one or more functioning processes of the financial organization. The one or more functioning processes are verified to check if each functioning process is in compliance with one or more regulatory rules of the plurality of regulatory rules.

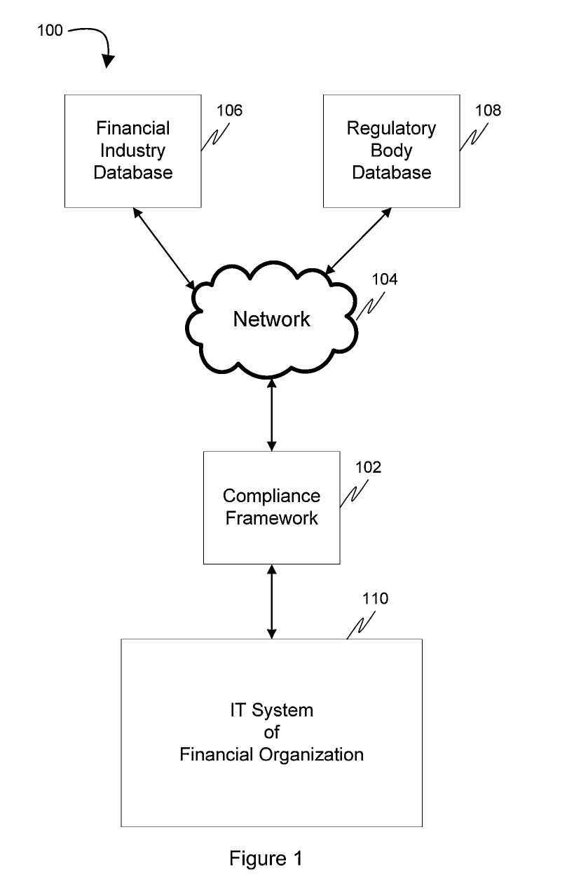

FIG. 1 illustrates a simplified diagram of a system 100 including a computer implemented compliance framework 102 configured to provide regulatory compliance check as a service to a financial organization in accordance with an embodiment of the invention. As illustrated in FIG. 1, compliance framework 102 is connected to a network 104. Network 104 may be one or more of, but not limited to, Local Area Network (LAN), Wide Area Network (WAN) and any other network that can be used to connect to Internet. Network 104 is configured to act as a medium to enable compliance framework 102 to connect to a financial industry database 106 to obtain information regarding a plurality of industry standard processes. Further, network 104 is configured to act as a medium to enable compliance framework 102 to connect to a regulatory body database 108 to obtain information regarding a plurality of regulatory rules. Compliance framework 102 is further configured to monitor operations of an IT system of a financial organization 110. The monitoring of operations enables compliance framework 102 to discover a plurality of business and operating rules of financial organization 110. This in turn enables compliance framework 102 to build an organization knowledge database.

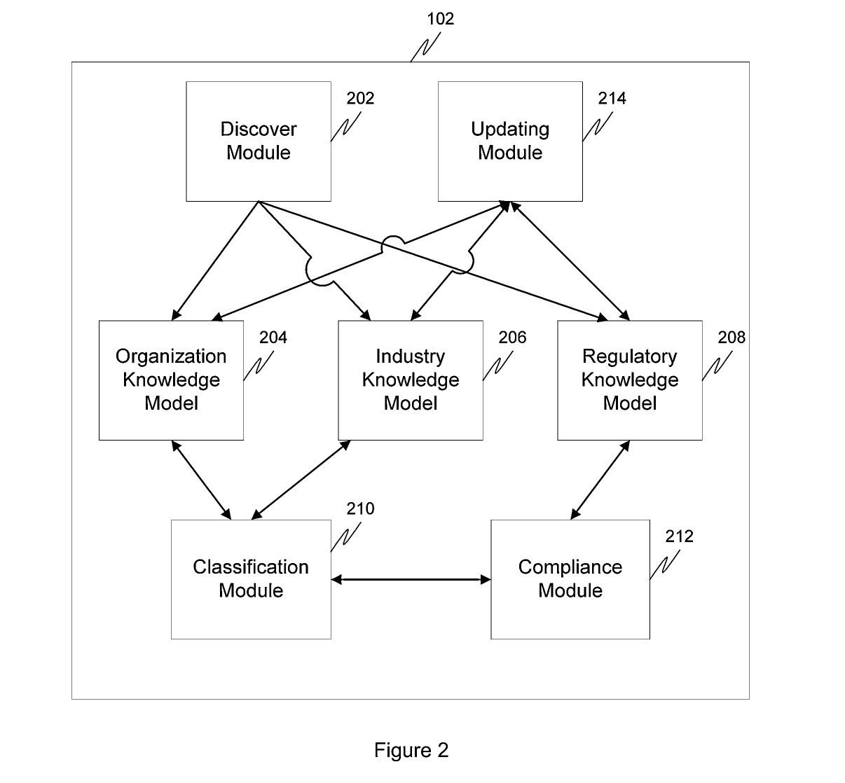

FIG. 2 illustrates computer implemented compliance framework 102 for providing regulatory compliance check as a service to financial organization 110 in accordance with an embodiment of the invention. Financial organization 110 is one or more of, but not limited to, a retail bank, an investment bank, a wholesale bank, a co-operative bank, a treasury, a building society, an insurance company, a stock exchange, a currency exchange, a futures exchange, a credit union, a trust company, a mortgage loan company, an asset management firm, a pension fund, a brokerage firm. As illustrated in FIG. 2, compliance framework 102 is configured to provide regulatory compliance check for financial organization 110 without modifying IT system of financial organization 110. IT system of the financial organization 110 is configured to conduct operations of financial organization 110. In an embodiment, compliance framework 102 is hosted on a server or a cloud platform, wherein the server or the cloud platform is integrated with IT system of financial organization 110 without modifying IT system of financial organization 110. In another embodiment, compliance framework 102 is implemented as an appliance that provides regulatory check as a service to financial organization 110. Compliance framework 102 is configured to monitor a plurality of events occurring in the financial organization and provide regulatory compliance checks without modifying the IT system.

In order to provide compliance framework 102 as a service to financial organization 110, compliance framework 102 includes a discover module 202 that is configured to discover a plurality of business and operating rules of financial organization 110. The discovery of the plurality of business and operating rules involves monitoring a plurality of events of financial organization 110 for a period of time. The plurality of events may be one or more of, but not limited to, a plurality of transactions conducted in financial organization 110 and data collection events occurring in financial organization 110. A transaction in financial organization 110 may be a financial transaction and/or a data collection transaction. The period of time may be one or more of, but not limited to, one or more days, one or more weeks and one or more months. During the period of time, discover module 202 is configured to analyze the plurality of events occurring in financial organization 110 and discover one or more business rules of financial organization 110. This enables discover module 202 to understand one or more rules and regulations of financial organization 110. Additionally, the discovery of the operating rules of financial organization 110 enables discovery module 202 to understand one or more functioning processes of financial organization 110. Upon discovering the plurality of the business and operating rules, discovery module 202 is configured to create an organization knowledge model 204. Organization knowledge model 204 is a database that includes the business and operating rules along with policies of financial organization 110. Organization knowledge model 204 is configured to classify the business and operating rules and store the business and operating rules according to the classification.

Additionally, discover module 202 is configured to create an industry knowledge model 206 and a regulatory knowledge model 208. Industry knowledge model 206 is a database that includes a plurality of industry standard processes for a financial industry. Industry standard processes include rules and regulations that have been defined by the financial industry for operations of financial organization 110. Industry knowledge model 206 is configured to comprehend all aspects of the plurality of industry standard processes for the financial industry. Similarly, regulatory knowledge model 208 is a database that includes a plurality of regulatory rules defined by a regulatory body. The regulatory body is a public body or government body mandated under terms of a legislative act to ensure that financial organization 110 is operating in compliance with provisions of the legislative act. The plurality of regulatory rules is defined in the legislative act.

In addition, compliance framework 102 includes a classification module 210 configured to classify each event of the plurality of events occurring in financial organization 110. Classification module 210 is configured to extract data from each event of the plurality of events. The extracted data enables classification module 210 to classify each event according to data obtained from organization knowledge model 204 and industry knowledge model 206. In an embodiment, classification module 210 classifies each event according to one or more of, but not limited to, one or more organization units of financial organization 110, one or more products associated with financial organization 110, one or more customer characteristics, one or more jurisdictions and one or more regulatory regimes. The classification of each event enables identifying each event according to a particular category.

As illustrated in FIG. 2, compliance framework 102 also includes a compliance module 212, configured to check if each event is in compliance with one or more regulatory rules defined by the regulatory body. A category of each event is identified and one or more regulatory rules that are applicable for such an event are determined. Thereafter, it is checked whether the one or more regulatory rules that have been determined for the event have been adhered upon or not. If the one or more regulatory rules have not been followed, then a flag is raised and information regarding such events is stored. Similarly, if the one or more regulatory rules have been followed, then information regarding such events is stored. Thereafter, a compliance report regarding compliance checks of each event of the plurality of events is stored. Additionally, compliance module 212 is configured to check one or more functioning processes of one or more organization units of financial organization 110. The compliance report may include data regarding the check performed on the one or more functioning processes of financial organization 110. The compliance report may be sent to a regulator of the regulatory body. Likewise, the compliance report may be sent to an auditor for further verification. Based on the compliance report, compliance module 212 is configured to provide recommendations for updating one or more of the business and operating rules. In an embodiment, the recommendations may be provided by the regulator or the auditor to improve operations of financial organization 110.

Compliance module 212 is further configured to submit a subset of data corresponding to a plurality of events to the regulatory body. The subset of data is a portion of data corresponding to the plurality of events in financial organization 110 that is required by the regulatory body. The subset of data is selected based on the plurality of regulatory rules.

Additionally, compliance framework 102 includes an updating module 214 configured to update one or more of, organization knowledge model 204, industry knowledge model 206 and regulatory knowledge model 208. Updating module 214 is configured to identify any new regulatory rules and new industry standard processes that have been defined by the regulatory body and the financial industry, respectively. In an embodiment, the new regulatory rules and the new industry standard processes may be provided to updating module 214 to update one or more of, organization knowledge model 204, industry knowledge model 206 and regulatory knowledge model 208. Updating module 214 is further configured to detect any changes or modifications in the regulatory rules and the industry processes. Once the new regulatory rules and new industry standard processes have been identified, then updating module 214 updates regulatory knowledge model 208 and industry knowledge model 206. In addition, updating module 214 determines if there are any changes to the business and operating rules of financial organization 110. The changes may include new business and operating rules and modifications to the existing business and operating rules of financial organization 110. Accordingly, updating module 214 updates organization knowledge model 204.

In an embodiment, compliance framework 102 may be operated using a Graphical User Interface (GUI). The GUI is configured to display each event occurring in financial organization 110. Additionally, the GUI is configured to display a compliance status of each event in financial organization 110. The compliance status of each event may be provided to one of a regulator and an auditor. The compliance status may be provided using a communication component of the GUI. The communication component is configured to enable a user to communicate with one or more of a regulator and an auditor.

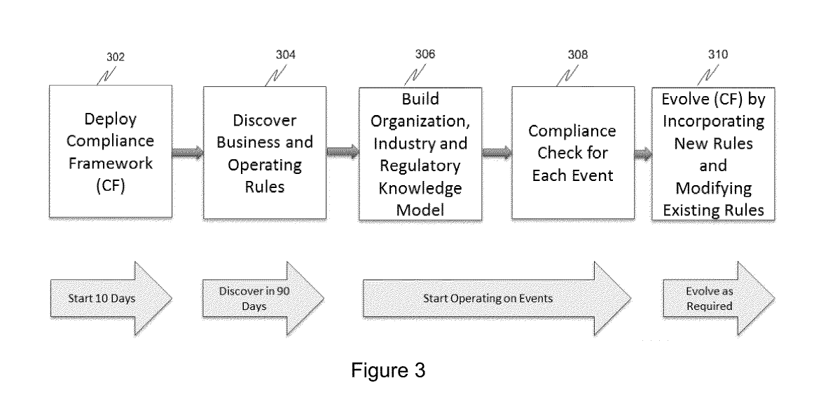

FIG. 3 illustrates an exemplary lifecycle of compliance framework 102 for providing regulatory compliance check as a service to financial organization 110 in accordance with an embodiment of the invention.

As illustrated in FIG. 3, at 302, compliance framework 102 is deployed as an appliance in financial organization 110. The deployment may be for a period 10 days. During this deployment period, compliance framework is integrated with IT system of financial organization 110 without making any modifications to IT system of financial organization 110. Thereafter, at 304, compliance framework 102 is configured to learn about operations of financial organization 110. For example, an operation of financial organization 110 may be obtaining personal details about a customer of the financial organization. The learning of financial organization 110 enables compliance framework 102 to discover a plurality of business and operating rules for financial organization 110. For example, a business/operating rule of financial organization 110 is to mandatorily obtain annual income of a customer while obtaining personal details of the customer. Compliance framework 102 may learn about the operations of financial organization 110 for a period of 90 days. After the completion of 90 days, at 306, compliance framework 102 may start creating an organization knowledge model that includes details about the business and operating rules of financial organization 110. After the completion of 90 days, compliance framework 102 is also configured to build an industry knowledge model and a regulatory knowledge model. The industry knowledge model is built based on a plurality of standard processes defined by the financial industry. Likewise, the regulatory knowledge model is built based on a plurality of regulatory rules as defined by a regulatory body. For example, a regulatory rule may be obtaining a Permanent Account Number (PAN) of a customer whenever the customer performs a transaction of above INR 50000.

At 308, compliance framework 102 is also configured to check for a compliance status for each event occurring in financial organization 110. For example, an event may be a money transfer transaction from one bank account to another bank account. This event may be classified as a transfer transaction based on the industry knowledge model and the organization knowledge model. Thereafter, compliance framework 102 is configured to check whether the event was executed in compliance with a plurality of regulatory rules as defined in the regulatory knowledge model.

There may be scenarios where, new regulations may be defined by a regulatory body or existing regulations may be modified. Similarly, new business and operating rules of the financial organization may be defined and new industry standard processes may be defined. Such changes are identified by compliance framework 102 at 310 as illustrated in FIG. 3. Compliance framework 102 incorporates such changes and evolves to check one or more events according to new rules and regulations.

An embodiment of the present application may relate to a computer program product with a non-transitory computer readable storage medium having computer code thereon for performing various computer-implemented operations of the method and/or system disclosed herein. The media and computer code may be those specially designed and constructed for the purposes of the method and/or system disclosed herein, or they may be of the kind well known and available to those having skill in the computer software arts. Examples of computer-readable media include, but are not limited to, magnetic media, optical media, magneto-optical media and hardware devices that are specially configured to store and execute program code. Examples of computer code include machine code, such as produced by a compiler, and files containing higher-level code that are executed by a computer using an interpreter. Additionally, programming languages suitable for implementing knowledge driven applications such as Prolog, LISP or functional programming languages such as Clojure may be used. Aspects of the present application may also be implemented using HyperText Transfer Protocol (HTTP), Procedural Scripting Languages and the like.

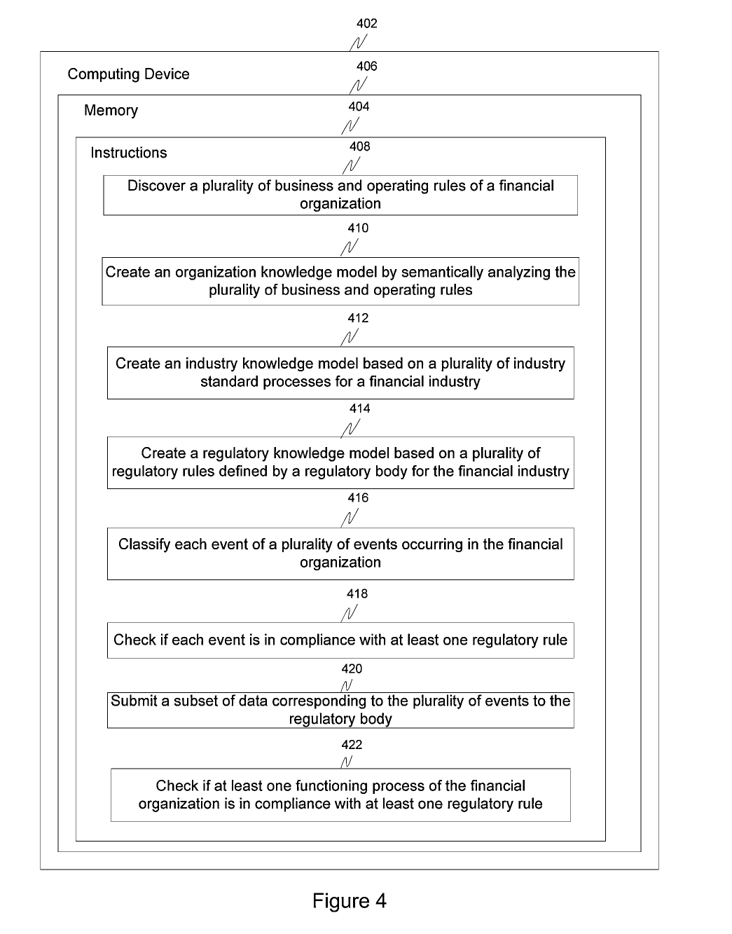

FIG. 4 illustrates a block diagram of a computing device 402 with one or more instructions 404 stored on a non-transitory computer-readable medium for providing regulatory compliance check as a service for a financial organization in accordance with an embodiment of the invention. Computing device 402 may include according to various exemplary embodiments of the invention, one or more of, a memory 406, a processor, and an input/output device. The processor is configured to execute one or more instructions 404 stored in memory 406 of computing device 402.

As illustrated in FIG. 3, one or more instructions 404 includes an instruction 408, which can be executed to discover a plurality of business and operating rules of the financial organization. Thereafter, instruction 410 can be executed to create an organization knowledge model by semantically analyzing the plurality of business and operating rules upon discovering the plurality of business and operating rules. Similarly, instruction 412 can be executed to create an industry knowledge model based on a plurality of industry standard processes for a financial industry. Further, instruction 414 can be executed to create a regulatory knowledge model based on a plurality of regulatory rules defined by a regulatory body for the financial industry.

Thereafter, a plurality of events occurring in the financial organization may be monitored. Each event of the plurality of events may be classified by executing instruction 416. The classification is based on the industry knowledge model and the regulatory knowledge model. An instruction 418 is executed to check if each event of the plurality of events is in compliance with one or more regulatory rules of the plurality of regulatory rules based on the classification of each event. Based on the classification of the event, one or more regulatory rules are identified that apply to a context of the event. The context of the event is applied to obtain a subset of data corresponding to the plurality of events to the regulatory body. Henceforth, an instruction 420 is executed to submit the subset of data corresponding to the plurality of events to the regulatory body. The subset of data is selected based on the plurality of regulatory rules. Additionally, one or more functioning processes of the financial organization are checked by executing an instruction 422. Instruction 422 is executed to check if each functioning process of the one or more functioning processes is in compliance with one or more regulatory rules.

The processor may be any commercially available terminal processor, or plurality of terminal processors, adapted for use in or with computing device 402 or compliance framework 102. A processor may be any suitable processor capable of executing/performing instructions. A processor may include a central processing unit (CPU) that carries out program instructions to perform the basic arithmetical, logical, and input/output operations of computing device 402 or compliance framework 102. A processor may include code (e.g., processor firmware, a protocol stack, a database management system, an operating system, or a combination thereof) that creates an execution environment for program instructions. A processor may include a programmable processor. A processor may include general and/or special purpose microprocessors. The processor may be operated by operating system software installed on memory. Compliance framework 102 may be implemented on a uni-processor system including one processor, or a multi-processor system including any number of suitable processors. Multiple processors may be employed to provide for parallel and/or sequential execution of one or more portions of the techniques described herein. Processes and logic flows described herein may be performed by one or more programmable processors executing one or more computer programs to perform functions by operating on input data and generating corresponding output. Processes and logic flows described herein may be one or more programmable processors executing one or more computer programs to perform functions by operating on input data and generating corresponding output.

Computing device 402 includes a non-transitory memory or more than one non-transitory memories (referred to as memory 406 herein). Memory 406 may be configured, for example, to store data, including computer program product or products, which include instructions for execution on the processor. Memory 406 may include, for example, both non-volatile memory, e.g., hard disks, flash memory, optical disks, and the like, and volatile memory, e.g., SRAM, DRAM, and SDRAM as required to support embodiments of the present invention. As one skilled in the art will appreciate, though memory 406 is depicted on, e.g., a motherboard, of computing device 402, memory 406 may also be a separate component or device, e.g., flash memory, connected to computing device 402 through an input/output unit or a transceiver. As one skilled in the art will understand, the program product or products, along with one or more databases, data libraries, data tables, data fields, or other data records can be stored either in memory 406 or in separate memory (also non-transitory), for example, associated with a storage medium such as a database locally accessible to computing device 402 positioned in communication with computing device 402 through the I/O device.

Non-transitory memory may further include drivers, modules, libraries, or engines to function as a dedicated software/hardware system (i.e., a software service running on a dedicated computer) such as an application server, web server, database server, file server, home server, standalone server. For example, non-transitory memory can include a server-side markup language processor (e.g., a PHP processor) to interpret server-side markup language and generate dynamic web content (e.g., a web page document) to serve to client devices over a communications network.

The method and system disclosed herein assists in implementing a compliance framework for providing regulatory compliance check as a service to a financial organization. The compliance framework provides a holistic, highly automated, and sustainable approach for implementing financial services regulatory compliance within and across multiple regulatory regimes. The compliance framework may reduce burden, cost and time required for complying with multiple regulatory regimes. The compliance framework may further reduce errors that are likely to occur when compliance requirements are identified manually. The compliance framework is implemented as a non-intrusive service and hence does not disturb existing infrastructure of the financial organization.

Those skilled in the art will realize that the above-recognized advantages and other advantages described herein are merely exemplary and are not meant to be a complete rendering of all of the advantages of the various embodiments of the present application. Additionally, embodiments need not achieve these, or another advantage, and should not be limited there to.

In the foregoing specification, specific embodiments of the present application have been described. However, one of ordinary skill in the art appreciates that various modifications and changes can be made without departing from the scope of the present application as set forth in the claims below. Accordingly, the specification and figures are to be regarded in an illustrative rather than a restrictive sense, and all such modifications are intended to be included within the scope of the present application. The benefits, advantages, solutions to problems, and any element(s) that may cause any benefit, advantage, or solution to occur or become more pronounced are not to be construed as critical, required, or essential features, of the present application.

We claim:

1. A computer implemented compliance framework for providing regulatory compliance check as a service to a financial organization, the compliance framework comprising:
a discover module configured to discover a plurality of business and operating rules of the financial organization, wherein the discover module is further configured to:
create an organization knowledge model by semantically analyzing the plurality of business and operating rules in response to the discovery module discovering the plurality of the business and operating rules;
create an industry knowledge model based on a plurality of industry standard processes for a financial industry;
create a regulatory knowledge model based on a plurality of regulatory rules defined by a regulatory body for the financial industry;
a classification module configured to classify each event of a plurality of events occurring in the financial organization, wherein each event of the plurality of events are classified based on at least one of the organization knowledge model and the industry knowledge model;
a compliance module configured to:
check if each event of the plurality of events is in compliance with at least one regulatory rule of the plurality of regulatory rules based on a classification of the event, wherein the at least one regulatory rule is identified based on the classification of the event;
submit a subset of data corresponding to the plurality of events to the regulatory body, wherein selection of the subset of data is performed based on the plurality of regulatory rules; and
verify at least one functioning process of the financial organization to check if each functioning process of the at least one functioning process is in compliance with at least one regulatory rule of the plurality of regulatory rules.

2. The computer implemented compliance framework as claimed in claim 1, wherein the classification module is further configured to classify each event of the plurality of events into at least one of, at least one organization unit of the financial organization, products associated with the financial organization, customer characteristics, at least one jurisdiction and at least one regulatory regime.

3. The computer implemented framework as claimed in claim 1, wherein the classification module is further configured to extract data corresponding to the plurality of events occurring in the financial organization.

4. The computer implemented compliance framework as claimed in claim 1 further comprising an updating module configured to update at least one of the organization knowledge model, the industry knowledge model and the regulatory knowledge model.

5. The computer implemented compliance framework as claimed in claim 1, wherein the compliance module is further configured to generate a compliance report in response to the check of each event of the plurality of events and the at least one functioning process.

6. The computer implemented compliance framework as claimed in claim 1, wherein the compliance framework is hosted in a cloud platform.

7. The computer implemented compliance framework as claimed in claim 1, wherein the compliance framework is implemented as an appliance.

8. The computer implemented compliance framework as claimed in claim 1 further comprising a Graphical User Interface (GUI) configured to display a compliance status of each event of the plurality of events.

9. The computer implemented compliance framework as claimed in claim 8, wherein the GUI comprises a communication component configured to enable a user to communicate with at least one of a regulator and an auditor.

10. The computer implemented compliance framework as claimed in claim 9, wherein the communication component is further configured to provide a compliance status of each event of the plurality of events to the at least one of a regulator and an auditor.

11. The computer implemented compliance framework as claimed in claim 1 is further configured to enable at least one operational unit of the financial organization to perform at least one task in accordance with the plurality of regulations.

12. The computer implemented compliance framework as claimed in claim 5, wherein the compliance module is configured to provide recommendations for updating at least one of the plurality of business and operating rules based on the compliance report.

13. A non-transitory computer readable medium storing a computer program for causing a computing device to perform a method for providing regulatory compliance check as a service for a financial organization, the method comprising:
discovering a plurality of business and operating rules of the financial organization, wherein the discovering comprises:
creating an organization knowledge model by semantically analyzing the plurality of business and operating rules in response to discovering the plurality of business and operating rules of a financial organization;
creating an industry knowledge model based on a plurality of industry standard processes for a financial industry; and
creating a regulatory knowledge model based on a plurality of regulatory rules defined by a regulatory body for the financial industry;
classifying each event of a plurality of events occurring in the financial organization, wherein each event of the plurality of events are classified based on at least one of the organization knowledge model and the industry knowledge;
checking if each event of the plurality of events is in compliance with at least one regulatory rule of the plurality of regulatory rules based on a classification of the event, wherein the at least one regulatory rule is identified based on the classification of the event;
submitting a subset of data corresponding to the plurality of events to the regulatory body, wherein selection of the subset of data is performed based on the plurality of regulatory rules; and
verifying at least one functioning process of the financial organization to check if each functioning process of the at least one functioning process is in compliance with at least one regulatory rule of the plurality of regulatory rules.
